(19) United States
(12) Patent Application Publication
(10) Pub. No.: US 2026/0287770 A1
(43) Pub. Date: Sep. 24, 2026

(54) AGENTIC ARTIFICIAL INTELLIGENCE FOR SEISMIC DISCOVERY

(71) Applicant: Schlumberger Technology Corporation, Sugar Land, TX (US)

(72) Inventors: Arvind Sharma, Houston, TX (US); Haibin Di, Houston, TX (US); Jing Wu, Houston, TX (US); Anatoly Aseev, Menlo Park, CA (US); Atul Laxman Katole, Houston, TX (US); Babu Sai Sampath Reddy Vinta, Houston, TX (US)

(21) Appl. No.: 19/570,264

(22) Filed: Mar. 18, 2026

Related U.S. Application Data
(60) Provisional application No. 63/773,521, filed on Mar. 18, 2025.

(51) Int. Cl. G01V 1/28; G01V 1/34; G06F 16/2457

(52) U.S. Cl. CPC G01V 1/282; G01V 1/345; G01V 2210/64; G06F 16/24578

(57) ABSTRACT

An artificial intelligence (AI) agent receives a natural language request from a user application to retrieve a seismic survey having a seismic profile matching a reference seismic profile of a geological model. A large language model (LLM) processes the natural language request to generate processing steps and identify corresponding tools to retrieve the seismic survey. The AI agent constructs an execution graph based on the processing steps. The execution graph includes instantiating nodes corresponding to the tools for the processing steps, and edges connecting the nodes. The AI agent executes the execution graph to obtain the seismic survey having the seismic profile matching the reference seismic profile.

### CROSS-REFERENCE TO RELATED APPLICATIONS

This application is a non-provisional application of, and hereby claims benefit under 35 U.S.C. § 119(e), to U.S. Provisional Application Serial No. 63/773,521, filed on Mar. 18, 2025. U.S. Provisional Application Serial No. 63/773,521 is incorporated herein by reference.

### BACKGROUND

Oil and gas field exploration projects may depend on timely identification of geologic traps that hold fuel reserves. The oil and gas field exploration projects include operational workflows that have expert review of a multitude of seismic surveys. The seismic surveys may span many basins, vintages, processing conditions, and acquisition geometries. The expert review may entail repetitive navigation through seismic sections and subjective comparison against structural and stratigraphic patterns.

The oil and gas field exploration projects have project schedules that may be constrained by limited expert availability to perform the expert review, uneven data quality of the seismic surveys, inconsistent metadata in the seismic surveys, and fragmented storage of the data across archives. Further, the oil and gas field exploration projects may have further challenges as survey volumes expand.

Technical challenges may arise from heterogeneity in seismic data in the seismic surveys and context information. Seismic sections from different seismic surveys may include divergent features that hinder comparison. Search operations over large seismic archives may lack standardized reference patterns. A further technical challenge may arise in that manual seismic interpretation may not have capabilities to leverage digital representations of geologic traps.

### SUMMARY

In general, an artificial intelligence (AI) agent receives a natural language request from a user application to retrieve a seismic survey having a seismic profile matching a reference seismic profile of a geological model. A large language model (LLM) processes the natural language request to generate processing steps and identify corresponding tools to retrieve the seismic survey. The AI agent constructs an execution graph based on the processing steps. The execution graph includes instantiating nodes corresponding to the tools for the processing steps, and edges connecting the nodes. The AI agent executes the execution graph to obtain the seismic survey having the seismic profile matching the reference seismic profile.

Other aspects of one or more embodiments will be apparent from the following description and the appended claims.

### BRIEF DESCRIPTION OF DRAWINGS

FIG. 1 shows a computing system, in accordance with one or more embodiments.

FIG. 2 shows a flowchart of a method, in accordance with one or more embodiments.

FIG. 3 shows a flowchart of a method, in accordance with one or more embodiments.

FIGS. 4 and 5 show an example, in accordance with one or more embodiments.

FIGS. 6.1 and 6.2 show a computing system, in accordance with one or more embodiments.

Like elements in the various figures are denoted by like reference numerals for consistency.

### DETAILED DESCRIPTION

One or more embodiments are directed to an artificial intelligence (AI) agentic system. The AI agentic system transforms an exploration request in natural language into a machine executable workflow for locating seismic surveys having seismic profiles that are similar to a seismic profile generated from a conceptual (including completely hypothetical) geological model. The machine executable workflow may generate a seismic profile from the conceptual geological model, search across seismic survey archives for matching seismic profiles, rank candidate seismic surveys, and prepare outputs for interpretation platforms.

More specifically, an AI agent may receive a natural‑language request from a user that asks for retrieval of a seismic survey containing at least one seismic profile that matches a reference seismic profile associated with a geological model. Responsive to the natural language request, a large language model (LLM) may process the natural‑language request and may generate a set of processing steps together with named tools that accomplish the retrieval objective. The AI agent may construct an execution graph from the generated processing steps. The execution graph has nodes that represent individual tools and edges that represent data‑flow relationships between tool outputs and tool inputs. The AI agent may execute the constructed execution graph to obtain a seismic survey that contains at least one seismic profile matching the reference seismic profile associated with the geological model.

The machine executable workflow implemented by the execution graph may begin with generation of a geological model representation and a corresponding geological model image derived from user‑provided descriptions of structural or stratigraphic features. Through forward modeling, the geological model representation is used to generate a reference seismic profile. During a similarity search, seismic sections across multiple survey archives are searched to identify candidate locations and seismic surveys having seismic profiles that align with the reference seismic profile. In a recommendation stage, similarity scores may be aggregated to produce a ranked list of seismic surveys with potential to have viable matches of the geological model. A dense evaluation of the recommended survey may analyze sub‑windows within the recommended survey to generate a heatmap that indicates spatial distribution of similarity. A connector stage may export the geological model, the reference seismic profile, the recommended seismic survey, and the heatmap to a subsurface interpretation platform for validation and further analysis.

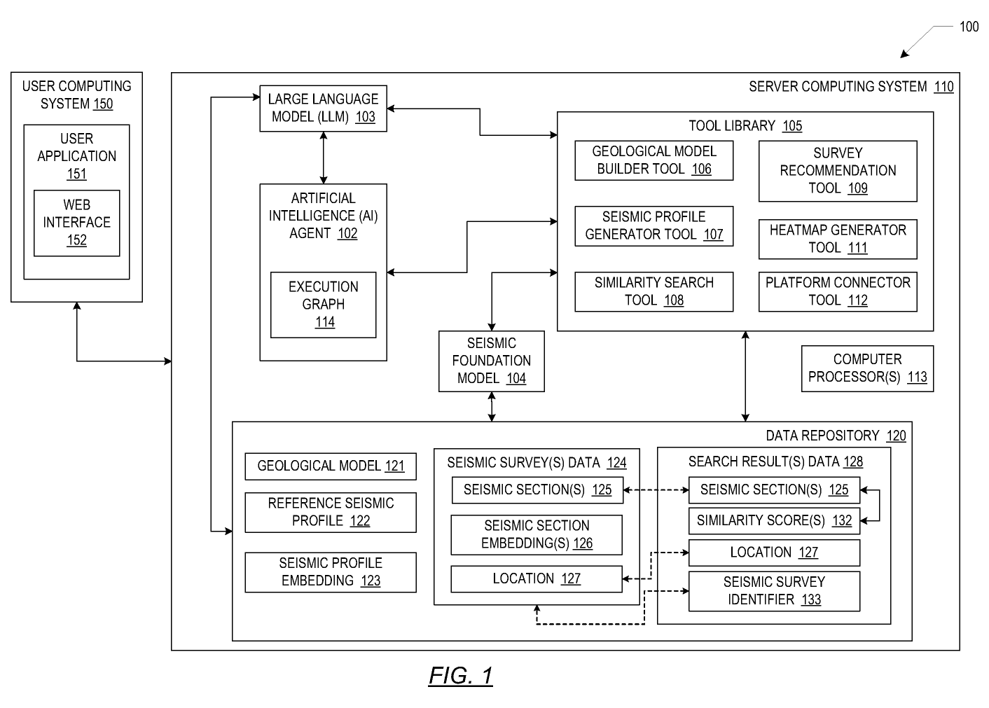

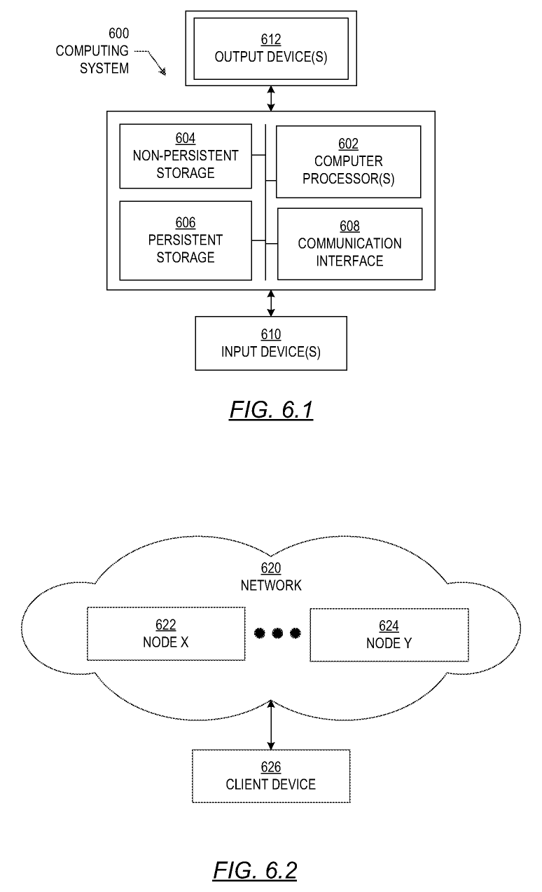

Attention is now turned to the figures. FIG. 1 shows a computing system, in accordance with one or more embodiments. The system shown in FIG. 1 may include a server computing system (110). The server computing system (110) is one or more computer processors, data repositories, communication devices, and supporting hardware and software. The server computing system (110) may be in a distributed computing environment. The server computing system (110) includes a computer processor (113). The computer processor (113) is one or more hardware or virtual processors which may execute computer readable program code that defines one or more applications, such as the large language model (LLM) (103), the artificial intelligence (AI) agent (102), the seismic foundation model (104), and the geological model builder tool (106), the seismic profile generator tool(107), the similarity search tool (108), the survey recommendation tool (109), the heatmap generator tool (111) and platform connector tool (112) of the tool library (105). An example of the computer processor is described with respect to the computer processor(s) (602) of FIG. 6.1. Thus, the server computing system (110) is configured to execute one or more applications, such as the LLM (103), the AI agent (102), the seismic foundation model (104), and the geological model builder tool (106), the seismic profile generator tool (107), the similarity search tool (108), the survey recommendation tool (109), the heatmap generator tool (111) and platform connector tool (112) of the tool library (105). An example of a computer system and network that may form the server computing system (110) is described with respect to FIGS. 6.1 and 6.2.

Some terms as used in the current specification are described herein. A seismic profile is a data structure that includes amplitude values arranged along spatial and time or depth axes. A seismic profile may represent the synthetic or acquired seismic response of subsurface layers and structures. A seismic profile may be used as a reference pattern for similarity search, ranking, and dense evaluation. Specifically, one or more embeddings of the seismic profile may be computed for similarity search, ranking and dense evaluation operations.

A seismic section may be a two‑dimensional slice of seismic amplitude data extracted along an inline, crossline, or arbitrary direction. A seismic section may depict reflector geometries, amplitude variations, and structural or stratigraphic features. A seismic section may be used for visual interpretation. A seismic section may be considered as a visual representation of a seismic profile.

A sub‑window may be a bounded portion of a seismic section or seismic volume selected for localized similarity evaluation. A sub‑window may include a subset of traces and time or depth samples that preserve local reflector patterns. A collection of sub‑windows may support dense similarity mapping and heatmap generation.

A geologic trap may be a structural or stratigraphic configuration that may enable containment of hydrocarbons or other subsurface resources. A geologic trap may include sealing geometries such as anticlines, faults, unconformities, channel terminations, or pinch‑outs. A geologic trap may be represented as a conceptual geological model for forward modeling and seismic comparison.

The server computing system (110) includes a data repository (120). The data repository (120) is a type of storage unit or device (e.g., a file system, database, data structure, or any other storage mechanism) for storing data. The data repository (120) may include multiple different, potentially heterogeneous, storage units and/or physical storage devices.

The data repository (120) includes a geological model (121). The geological model (121) may be a structured representation of a conceptual subsurface configuration, for example, a geologic trap. The geological model (121) may be generated by the geological model builder tool from an initial description in natural‑language and tool‑assisted parameter extraction. The geological model (121) may be defined in depth or time coordinates and may include feature parameters for folds, faults, salt bodies, channels, and stratigraphic pinch‑outs. The geological model (121) may further include layer boundaries and physical property values such as velocity, density, or acoustic impedance. In one or more embodiments, the geological model (121) may be stored as a hierarchical document such as JavaScript Object Notation (JSON) format or eXtensible Markup Language (XML) format. In other embodiments, the geological model (121) may be stored as a parametric object set, as surface meshes in OBJ or PLY formats, as gridded volumes in SEG‑Y or Zarr formats, or as a graph of features and relationships persisted in a property graph database. The inputs of the geological model (121) may be derived from an AI‑mediated interpretation loop that normalizes units, validates ranges, and resolves missing parameters before downstream generation.

The data repository (120) further includes a reference seismic profile (122). The reference seismic profile (122) may be an amplitude grid produced by forward modeling of the geological model (121) using, for example, a wavelet and reflectivity computation. The forward modeling may be performed by the seismic foundation model. The reference seismic profile (122) may be stored as a two‑dimensional array for a line, a slice extracted from a three‑dimensional cube, or a tiled collection of traces aligned to an inline–crossline–time index. Example logical data structures may include NumPy‑style arrays serialized in NPZ, chunked cloud arrays such as Zarr, HDF5 datasets, or SEG‑Y traces with survey headers preserved for alignment. The reference seismic profile (122) may be associated with provenance metadata identifying the governing model version, wavelet parameters, sampling rates, and stochastic seeds used to generate the synthetic response.

The data repository (120) further includes a seismic profile embedding (123). The seismic profile embedding (123) may be a vector or a set of vectors that encode the synthetic profile into a semantic space suitable for similarity search. The embedding may be computed over the full profile or over tiles of the profile, and may include normalization factors, projection identifiers, and dimensionality descriptors. The embedding may be obtained from the seismic foundation model, specifically, the output from the encoder layer of the seismic foundation model. Example logical data structures may include dense float tensors stored in NPZ, Parquet columnar tables or key–vector maps in a vector database having approximate nearest neighbor indexing. The seismic profile embedding (123) corresponds to the reference seismic profile (122).

The data repository (120) includes seismic survey(s) data (124). The seismic survey(s) data (124) may be an indexed collection of real survey artifacts and associated metadata used for retrieval and downstream analysis. The seismic survey(s) data (124) further includes seismic section(s) (125). The seismic section(s) (125) may be line images, inline or crossline slices, or other cutouts extracted from field or processed volumes, and may be stored as SEG‑Y traces, tiled images, or chunked arrays aligned to survey coordinates. The seismic survey(s) data (124) further includes seismic section embedding(s) (126). The seismic section embedding(s) (126) are vector representations of corresponding seismic sections (125). The seismic section embeddings (126) support nearest‑neighbor search against the seismic profile embedding (123). The seismic section embeddings (126) may be stored as float tensors, Parquet vectors, or entries in a vector index with keys that reference section identifiers and sub‑window coordinates. The seismic survey(s) data (124) further includes a location (127). The location (127) may be geo‑referenced descriptors such as basin name, survey name, geographic coordinates, inline and crossline ranges, and time or depth windows. The location (127) and may be stored as normalized metadata records in a relational table or document store.

The data repository (120) includes search result(s) data (128). The search result(s) data (128) may be generated by comparing the seismic profile embedding (123) against the seismic section embedding(s) (126) and by collecting the high scoring candidates across one basin or across multiple basins. The search result(s) data (128) further includes seismic sections (125) of the seismic survey data (124). A seismic section may be a two‑dimensional slice of seismic amplitude data that includes a sequence of seismic traces arranged along a spatial axis such as an inline or crossline direction. A seismic section may show amplitude variations as a function of time or depth and may be used to visualize structural or stratigraphic features in subsurface data. A seismic section may be obtained by acquiring seismic data along a survey line or by extracting a slice from a three‑dimensional seismic volume. A seismic section may be stored as seismic traces in SEG‑Y format or as a gridded array of amplitude values suitable for similarity search and interpretation.

A seismic section is the display form of seismic data (a 2D image). A seismic profile is the data form of seismic amplitudes (the numeric amplitude grid). A seismic section is the visual representation of at least a portion of a corresponding underlying seismic profile. Thus, a top-ranked seismic survey may have a seismic profile, rendered as a seismic section, which matches the reference seismic profile of the geological model.

The search result(s) data (128) further includes similarity score(s) (132). The similarity score(s) (132) may be numeric values produced by an embedding similarity function and may be stored as floating‑point fields. The search result(s) data (128) further includes a location (127). The location (127) within the results may be the spatial context of the retrieved seismic section(s) such as inline and crossline indices, time or depth windows, and geographic tags. The search result(s) data (128) further includes a seismic survey identifier (133). The seismic survey identifier (133) may map the search result to the seismic survey data (124) for seismic survey ranking and recommendation. The search result(s) data (128) may be derived from a multitude of tools that perform embedding computation on the reference seismic profile (122) on demand and query a vector index of the seismic section embedding(s) (126).

The data repository (120) may be implemented over storage layers that include object storage for large arrays and images, a vector index for embeddings, a relational or document store for metadata and locations.

The server computing system (110) further includes an AI agent (102). The AI agent (102) is software or application-specific hardware, which, when executed on the one or more computer processors (113) orchestrates and controls the construction and execution of the execution graph (114), interacts with the LLM (103) to obtain actions and inputs from natural language requests, and manage tool calls within the tool library (105) and the seismic foundation model (104). In operation, the AI agent orchestrates the workflow of retrieving a seismic survey having a likelihood of geologic traps and other structures that are closest to the geological model (121) conceptualized in a user application.

The AI agent (102) includes an execution graph (114). An execution graph is a machine‑readable representation of a workflow in which operations are expressed as nodes, and data or control dependencies between the operations are expressed as directed edges. An execution graph may be evaluated by the AI agent (102) in a runtime system that schedules a node for execution provided that the nodes supplying the inputs for the particular node have completed execution. The execution graph may encode ordering, branching, merging, and data‑flow relationships so that a sequence of computational steps may be executed deterministically or conditionally based on the structure of the graph. Execution graphs may be used in agentic orchestration systems to coordinate the evaluation of multiple steps having an interdependence of outputs. Accordingly, the execution graph (114) includes a multitude of tool nodes (i.e., nodes), the tool node representing an operational step that may be executed by a corresponding tool in the tool library (105). A tool node may be defined as an in-memory structure identifying a referenced tool and one or more data dependencies that link the tool node to upstream or downstream tool nodes. A tool node may include an in‑memory state that holds inputs, intermediate buffers, and outputs during execution. The AI agent (102) may instantiate the in‑memory state when scheduling the tool node. The execution graph (114) may have a directed acyclic representation of sequential or conditional execution of nodes enforcing ordering constraints. For example, the geological model builder tool (106) may be constrained to complete execution prior to scheduling the seismic profile generator tool (107).

The server computing system includes an LLM (103). The LLM (103) includes a reasoning engine that may be configured to transform natural‑language descriptions into structured parameters and to generate a machine‑readable workflow for the execution graph (114). The LLM (103) may be derived from a transformer architecture trained on heterogeneous corpora and may operate over a context window that accepts prompt text, system policy text, intermediate tool outputs, and control metadata. Inputs may include user utterances, schema templates, few‑shot exemplars, and function specifications that describe tool inputs and outputs. Outputs may include parameter extractions for geological features, workflow step proposals, natural‑language explanations, and function‑call payloads. The AI agent (102) may route the outputs to tools in the tool library (105). The LLM (103) may be accessed through safeguarded endpoints via API calls, or via chatbot interfaces.

The server computing system (110) includes a seismic foundation model (104). The seismic foundation model (104) is a transformer model configured with domain‑specific capabilities that may be invoked by tools to produce synthetic seismic profiles, compute embeddings, retrieve similar seismic sections, and evaluate similarity across sub‑windows of seismic surveys. The seismic foundation model (104) may be derived from pretrained seismic encoders and decoders exposed. The seismic foundation model (104) may be trained on vast corpora of seismic survey data and other seismic data.

The server computing system (110) further includes a tool library (105). The tool library (105) includes tools that the AI agent (102) triggers to execute, according to the workflow plan. Specifically, tool library (105) includes a geological model builder tool (106). The geological model builder tool (106) may be configured to accept feature parameters extracted by the LLM (103) to produce a structured representation of a geological model together with a corresponding model image.

The tool library (105) further includes a seismic profile generator tool (107). The seismic profile generator tool (107) may be configured to transmit the structured representation to the seismic foundation model (104) for forward modeling and to return a synthetic seismic profile as an amplitude grid suitable for downstream matching.

The tool library (105) further includes a similarity search tool (108). The similarity search tool (108) may be configured to compute or obtain embeddings of the reference seismic profile and query the seismic foundation model (104) for nearest neighbors across one basin or across multiple basins using a sparse‑sample search.

The tool library (105) further includes a survey recommendation tool (109). The survey recommendation tool (109) may be configured to aggregate section‑level matches by seismic survey. Further, the survey recommendation tool (109) may compute seismic survey ranking values using aggregation functions, and output one recommended survey or a short list for dense analysis.

The tool library (105) further includes a heatmap generator tool (111). The heatmap generator tool (111) may be configured to request that the seismic foundation model (104) obtain sub‑windows of the recommended survey, evaluate similarity between the sub‑windows and the reference seismic profile, and assemble a heatmap aligned to survey coordinates that indicates relative prospectivity.

The tool library (105) further includes a platform connector tool (112). The platform connector tool (112) may be configured to package the geological model, the synthetic seismic profile, the recommended survey context, and the heatmap for delivery to a subsurface interpretation platform and to export registration and color‑map metadata for correct overlay.

The system (100) is connected to or includes a user computing system (150). The user computing system (150) may be considered remote or local. A remote user computing system may be operated by a third-party (e.g., an end user of a chatbot) that does not control or operate the system of FIG. 1. Similarly, the organization that controls the other elements of the system of FIG. 1 may not control or operate the remote user computing system. Thus, a remote user computing system may not be considered part of the system of FIG. 1. In contrast, a local user computing system is operated under the control of the organization that controls the other components of the system of FIG. 1. Thus, a local user computing system may be considered part of the system of FIG. 1.

The user computing system (150) is a computing system used by a user to submit a user query. The user computing system (150) may include a display for displaying the web interface (152) of a user application (151) and an input device for receiving input from the user. The user computing system (150) may further include a network interface for connecting the user computing system (150) to the server computing system (110). The user computing system (150) may be configured to execute the user application (151) with the web interface (152). In one or more embodiments, the user application (151) may be a web-based client application, operating within a web browser. Other embodiments of the user application (151) may include native desktop applications, mobile applications, remote desktop clients, etc.

While FIG. 1 shows a configuration of components, other configurations may be used without departing from the scope of one or more embodiments. For example, various components may be combined to create a single component. As another example, the functionality performed by a single component may be performed by two or more components.

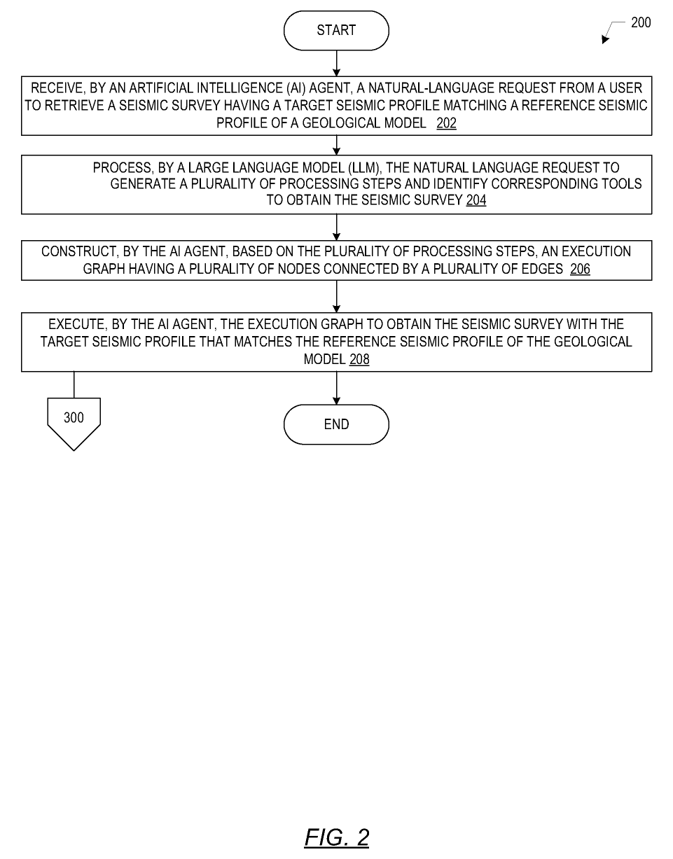

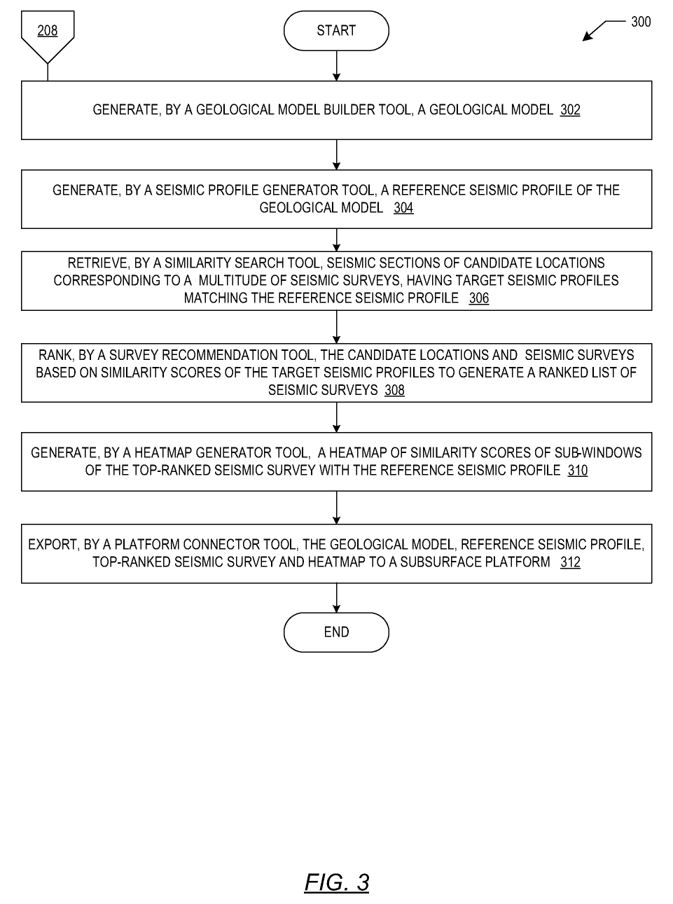

FIG. 2 shows a flowchart 200 of a method for constructing an agentic workflow to generate a geological model retrieve seismic surveys having structures that are similar to the geological model, in accordance with one or more embodiments. The method of FIG. 2 may be implemented using the system of FIG. 1 and one or more of the steps may be performed on or received at one or more computer processors. While the various steps in flowchart 200 are presented and described sequentially, at least some of the steps may be executed in different orders, may be combined or omitted, and at least some of the steps may be executed in parallel. Furthermore, the steps may be performed actively or passively. The steps of Block 208 of FIG. 2 are described in further detail in reference to the method of FIG. 3.

In Block 202, a natural‑language request from a user to retrieve a seismic survey having at least one seismic profile matching a reference seismic profile of a geological model is received by an AI agent. In one or more embodiments, a natural language request may be received by the AI agent. The natural language request may include a directive to obtain a seismic survey that includes at least one seismic profile that matches a reference seismic profile of a geological model. In one or more embodiments, the received natural language request may be generated by a geoscientist or by an automated system that supplies descriptive information regarding a structural or stratigraphic configuration. The natural language request may include feature terms, basin terms, project constraints, which correspond to conceptual geological features. In one or more embodiments, the natural language request may be parsed for timing signals, context phrases, or feature descriptors that the AI agent may forward to an LLM for further processing. The AI agent may store the received natural‑language request in session memory and may attach metadata such as timestamps, user identifiers, and workflow identifiers for reproducibility.

In Block 204, the natural language request is processed by the LLM to generate a multitude of processing steps and identify corresponding tools to obtain the seismic survey. In one or more embodiments, the natural language request may be processed by the LLM to generate a multitude of processing steps and identify corresponding tools that may be used to obtain the seismic survey. The LLM may analyze the natural‑language request to extract geological features, interpret operational intents, and map descriptive phrases into structured representations that reference tools available in a tool library. The multitude of processing steps may include recommendations for diverse tools of the tool library, for example, of a geological model builder tool, a seismic profile generator tool, a similarity search tool, a survey recommendation tool, and a heatmap generator tool. The processing steps may reflect dependencies between intermediate outputs. The LLM may supply the multitude of processing steps as a machine‑readable workflow description that the AI agent may use to create corresponding tool nodes in an execution graph.

In Block 206, an execution graph having a multitude of nodes connected by a multitude of edges is constructed by the AI agent based on the processing steps. Construction may include instantiation of the multitude of nodes for the corresponding tools of the processing steps. In one or more embodiments, the execution graph may be constructed by the AI agent based on the generated processing steps, and construction of the execution graph may include instantiating nodes for tools referenced in the generated processing steps. The execution graph may include directed edges that connect tool nodes according to data dependencies, such that outputs from one tool node may be routed along specific edges to downstream tool nodes. Additionally, or alternatively, outputs of the tool nodes may be routed to the AI agent. An instantiated node may include a reference to a tool in the tool library, a list of expected inputs, a list of outputs, and bindings to in‑memory state segments created by the AI agent. The execution graph may include ordering rules that ensure geological model construction precedes seismic profile generation, and that similarity searching and survey ranking occur after the synthetic seismic profile is made available.

In Block 208, the execution graph is executed by the AI agent to obtain the seismic survey having the at least one seismic profile that matches the reference seismic profile of the geological model. In one or more embodiments, the execution graph may be executed by the AI agent to obtain a seismic survey that includes the at least one seismic profile that matches the reference seismic profile of the geological model. Execution of the execution graph may include scheduling the tool nodes in the order dictated by the directed edges of the execution graph. Further tool inputs from upstream outputs may be provided. The tools may be invoked in accordance with their associated contracts.

In one or more embodiments, given a current tool having executed and returned an output, the AI agent may determine a next tool to trigger by evaluating outputs from tool nodes and by soliciting additional natural‑language input from a user application through an interaction loop. In one or more embodiments, a first tool at a first node of the execution graph may be triggered by the AI agent, and a first output may be generated by the first tool at the first node. The AI agent may transmit the first output to a user application for review or for refinement. A second natural‑language request may be received by the AI agent from the user application, based on the first output. The AI agent may prompt the LLM to process the second natural‑language request and to determine a second tool for generating a second output that corresponds to the second natural‑language request. The second tool at a second node of the execution graph may be triggered by the AI agent based on the tool determination returned by the LLM. Additional tool nodes may be scheduled using the same mechanism as new natural‑language requests are received or as intermediate outputs signal completion of earlier processing steps. The AI agent may update the in‑memory state associated with the second node to store input bindings for the second tool. Further, the AI agent may route output handles from upstream tool nodes into the second tool node according to dependency edges recorded in the execution graph. In one or more embodiments, execution of the seismic workflow to obtain a seismic survey having the at least one seismic profile that matches the reference seismic profile may take place in accordance with the method of FIG. 3.

FIG. 3 shows a flowchart 300 of a seismic workflow of seismic modeling tools that implement the workflow of obtaining a seismic survey having a seismic profile that matches a seismic profile of a geological model, in accordance with one or more embodiments. The method of FIG. 3 may be implemented using the system of FIG. 1 and one or more of the steps may be performed on or received at one or more computer processors. While the various steps in flowchart 300 are presented and described sequentially, at least some of the steps may be executed in different orders, may be combined or omitted, and at least some of the steps may be executed in parallel. Furthermore, the steps may be performed actively or passively. The steps of Block 208 of FIG. 2 are described in further detail in reference to the method of FIG. 3. That is, the method of FIG. 3 describes the actions performed in the seismic workflow that is executed in accordance with the execution graph. In the description of the method of FIG. 3, the underlying seismic profile of the seismic sections are compared to the reference seismic profile. Thus, the phrase “similarity scores of the seismic sections” refers to the similarity scores of the underlying seismic profiles of the seismic sections.

The similarity search and heatmap generation tasks may be performed by the seismic foundation model, which is specifically trained for performing similarity search and heatmap generation, in one or more embodiments.

In Block 302, a geological model may be generated by a geological model builder tool. In one or more embodiments, a geological model builder tool may be executed at a first node of an execution graph to perform operations to generate a geological model. The operations may include prompting a large language model to extract a multitude of features and corresponding feature values of a geological model from a natural‑language request. The operations may further include generating a geological model representation and a corresponding geological model image based on the multitude of features and corresponding feature values. The operations may further include transmitting the geological model and the geological model image to a user application. A geological model may include structured descriptions of structural or stratigraphic features such as folds, faults, salt bodies, channel forms, and pinch‑outs.

In one or more embodiments, the geological model builder tool may further participate in an interactive refinement loop to update the geological model based on additional natural language input from a user application. The operations of the interactive refinement loop may include receiving a second natural‑language request from the user application that includes a modification to a feature of the geological model. The operations may further include obtaining, from the large language model processing the second natural‑language request, updated feature data that includes the feature and a corresponding modified feature value. The operations may further include generating an updated geological model and a corresponding updated geological model image based on the updated feature data. The operations may further include transmitting the updated geological model and the updated geological model image to the user application. The geological model builder tool may repeat the interactive refinement cycle as additional natural‑language requests are provided, enabling iterative adjustment of structural or stratigraphic features in response to user direction.

In Block 304, a reference seismic profile of the geological model may be generated by a seismic profile generator tool. In one or more embodiments, a seismic profile generator tool may be executed at a second node of the execution graph to perform operations to generate a reference seismic profile of a geological model. The operations may include receiving an updated geological model representation generated in Block 302. The operations may further include transmitting a forward‑modeling request that includes the updated geological model representation to a seismic foundation model. The seismic foundation model may generate the reference seismic profile of the geological model by forward‑modeling the updated geological model representation. The operations may further include transmitting the reference seismic profile to a user application. A reference seismic profile may be generated as an amplitude grid that represents a synthetic seismic expression of the geological configuration. The reference seismic profile may be prepared for downstream matching operations.

In Block 306, seismic sections of candidate locations corresponding to a multitude of seismic surveys having seismic profiles matching the reference seismic profile may be retrieved by a similarity search tool. In one or more embodiments, a similarity search tool may be executed at a third node of the execution graph to perform operations to retrieve seismic sections of candidate locations. The operations may include receiving the reference seismic profile obtained in Block 304. The operations may further include generating an embedding of the reference seismic profile. The operations may further include transmitting the embedding to a seismic foundation model. The seismic foundation model may perform a sparse‑sample search using the embedding and may generate search results that include seismic sections, corresponding candidate locations of the seismic sections, and seismic survey identifiers. A “sparse‑sample search” refers to a similarity search over a large seismic corpus in which a subset of images or sub‑regions is evaluated initially to obtain representative similarity scores, the subset being selected according to a sampling policy (e.g., stratified by survey, basin, line index, or metadata). The results may be used to prioritize or prune surveys for subsequent evaluation, including dense similarity analysis. The search results may be selected such that similarity scores of embeddings of the underlying seismic profiles of the seismic sections to the embedding of the reference seismic profile may satisfy a similarity threshold. The operations may further include transmitting the search results and the multitude of candidate locations to an AI agent. The retrieved candidate sections may include spatial metadata and identifiers that support the ranking stage described in Block 308.

In Block 308, candidate locations and seismic surveys may be ranked by a survey recommendation tool to generate a ranked list of seismic surveys. In one or more embodiments, a survey recommendation tool may be executed at a fourth node of an execution graph to perform operations to generate a ranked list of seismic surveys. The operations may include receiving search results that include seismic sections, corresponding similarity scores, and corresponding candidate locations. The operations may further include computing a candidate location ranking based at least on similarity scores of the seismic sections to the reference seismic profile to obtain a ranked list of candidate locations. The operations may further include outputting a ranked list of seismic surveys corresponding to the ranked list of candidate locations. The operations may further include transmitting the ranked list of seismic surveys to an AI agent. A ranked list of seismic surveys may indicate which surveys include seismic profiles similar to the reference seismic profile generated from the geological model.

In Block 310, a heatmap of similarity scores of sub‑windows of a top‑ranked seismic survey with the reference seismic profile may be generated by a heatmap generator tool. In one or more embodiments, a heatmap generator tool may be executed at a fifth node of an execution graph to perform operations to generate a heatmap that represents similarity values. The operations may include receiving a top‑ranked seismic survey of the ranked list of seismic surveys obtained in Block 308, and the reference seismic profile. The operations may further include transmitting a request that includes the top‑ranked seismic survey and the reference seismic profile to a seismic foundation model. The seismic foundation model may obtain similarity scores between seismic profiles of a multitude of sub‑windows of the top‑ranked seismic survey and the reference seismic profile. The operations may further include generating a heatmap that represents the similarity scores. The operations may further include transmitting the heatmap to an AI agent. The heatmap may include spatially aligned similarity values that support visual interpretation and subsequent export.

In Block 312, the geological model, the reference seismic profile, the top‑ranked seismic survey, and the heatmap may be exported by a platform connector tool to a subsurface platform (e.g., Petrel^{®} subsurface platform). In one or more embodiments, a platform connector tool may be executed at a sixth node of an execution graph to perform operations to export outputs of a multitude of tools. The operations may include generating export formats for the geological model, the reference seismic profile, the top‑ranked seismic survey, and the heatmap. The operations may further include transmitting the export formats to a subsurface platform. The exported artifacts may be delivered in formats suitable for seismic interpretation environments, such as SEG‑Y, RESQML, GeoTIFF, or packaged metadata bundles used by subsurface platforms.

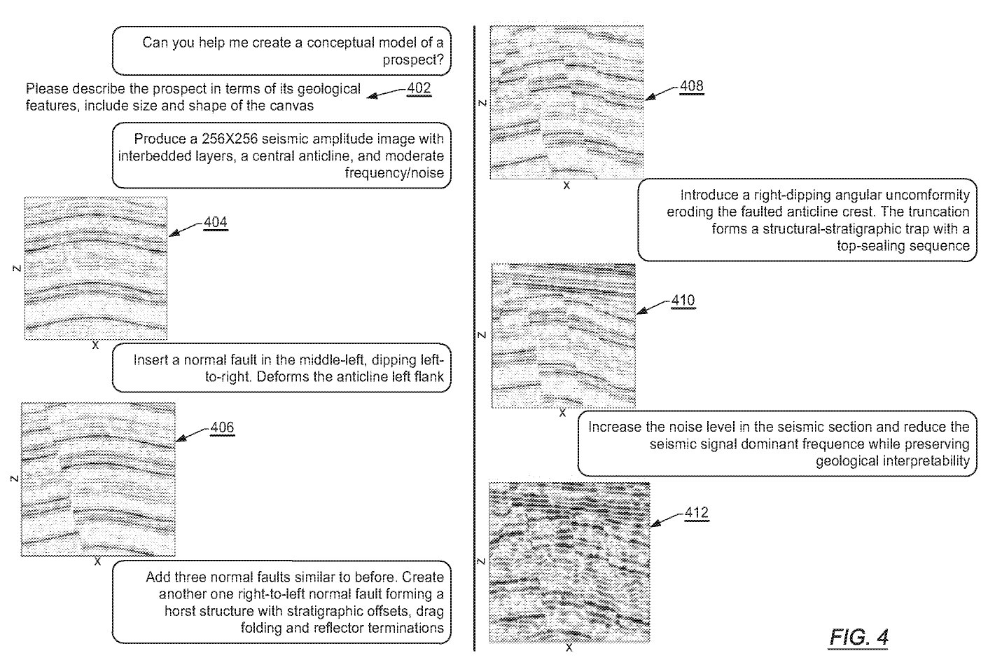

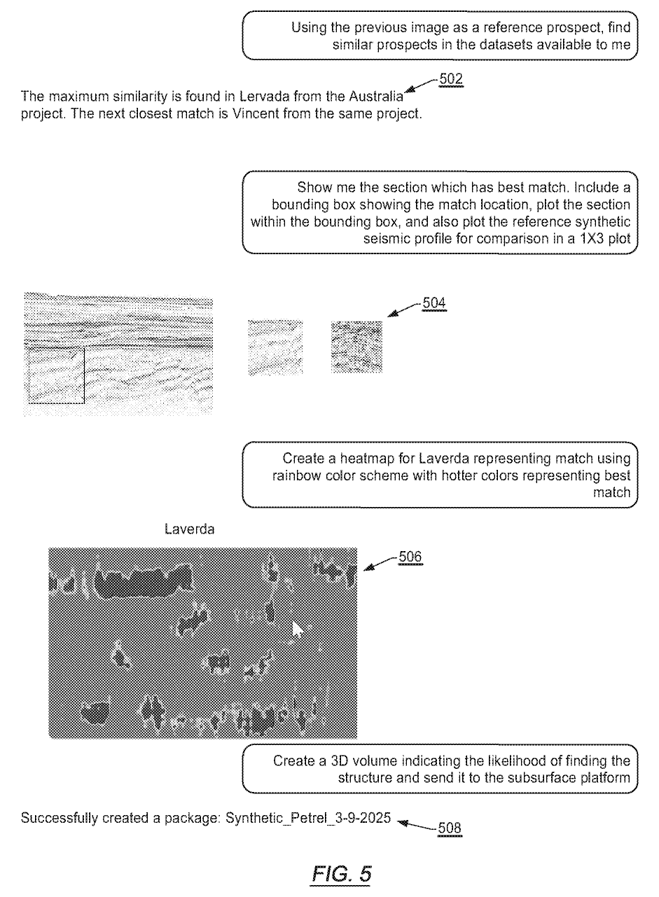

FIGS. 4 and 5 shows an example of an interactive session between a user and a seismic modeling application of a seismic workflow, implemented by the system of FIG. 1 and the methods of FIGS. 2 and 3, in accordance with one or more embodiments. The following example is for explanatory purposes only and not intended to limit the scope of one or more embodiments.

FIG. 4 depicts an example of an interactive geological model construction in a chat interface of a user interface. The example of FIG. 4 is presented in two columns with a dividing vertical line. The right column is a continuation of the chat interface of the left column. The chat interface includes user requests on the right side of a particular column in text boxes with dotted fill. The chat interface includes agentic outputs on the left side of the column without border.

A user request for assistance with creation of a conceptual model of a prospect is answered with an agent request (402) to describe the prospect in terms of geological features, including size and shape of the canvas. In one or more embodiments, the AI agent may prompt the LLM to respond with a multitude of features of a geological model for which the user should provide some feature values. The agent request (402) includes guidance that requests feature values such as target geometry, structural elements, and display extent. The guidance may be rendered in the user interface to initiate the instruction–understand–translate–invoke loop.

The user provides a directive to produce a “256×256 seismic amplitude image with interbedded layers, a central anticline and moderate frequency/noise”. Processing the directive, the system generates a rendered image (404). In one or more embodiments, the user request including extracted feature values for layered stratigraphy, anticline curvature, and frequency or noise controls may be used by the geological model builder tool to generate geological model image (404), and present the generated image for review. The geological model representation may be stored for subsequent forward modeling.

The user then transmits a refinement instruction to “insert a normal fault in the middle‑left, dipping left‑to‑right” and to “deform the anticline left flank.” Responsive to the refinement instruction, the AI agent may provide with a new agentic output (406) that includes a revised image reflecting the requested fault offset. The revised image depicts the requested fault geometry and associated drag or reflector terminations to demonstrate how structural edits impact the conceptual model.

A response to a direction to “Add three normal faults similar to before. Create another one right-to-left normal fault forming a horst structure with stratigraphic offsets, drag folding and reflector terminations” is depicted in image (408), showing three fault lines and the horst structure and to form a “structural‑stratigraphic trap with a top‑sealing sequence”.

In response to a subsequent request, “introduce a right‑dipping angular unconformity eroding the faulted anticline crest,” the AI agent generates a revised image (410) reflecting the unconformity and sealing sequence. In one or more embodiments, the geological model builder tool may generate an updated geological model image based on updated feature data that includes angular unconformity parameters and sealing layer descriptors. The updated geological model image may be transmitted to the user application for validation.

In response to a request to “increase the noise level in the seismic section and reduce the seismic signal dominant frequency while preserving geological interpretability,” the AI agent further adds noise and bandwidth perturbations to the image (412) so that the same controls may be used during generation of a synthetic seismic profile.

FIG. 5 depicts the retrieval, heatmap and export aspects of the seismic workflow in a user interface. The chat interface may be the same as in FIG. 4.

In the interface, the user issues the request, “Using the previous image as a reference prospect, find similar prospects in the datasets available to me.” An agentic summary (502) may be generated that reports “maximum similarity found in Laverda from the Australia project” and “next closest match is Vincent from the same project,” with candidate seismic sections displayed as thumbnails.

A user prompt that requests “the section which has best match,” a bounding box, a plot within the bounding box, and a “1×3 plot” comparison with a reference synthetic profile may be answered with an image (504) showing the requested comparison layout.

The AI agent outputs a heatmap (506) titled “Laverda” In response to a directive to “create a heatmap for Laverda representing match using rainbow color scheme with hotter colors representing best match” The heatmap highlight spatial clusters of high similarity and may guide follow‑on interpretation in a subsurface platform.

A message “Successfully created a package: Synthetic_Petrel_3‑9‑2025” (508) may be shown as an agentic confirmation of a directive to export the model, heatmap, seismic survey and other artifacts. The export package may include a geological model representation, a reference seismic profile, a selected seismic survey reference, and a heatmap aligned to survey coordinates.

The interactive session shown in FIGS. 4 and 5 may proceed through repeated cycles. The geological modeling cycle may produce a geological model representation and a geological model image. The retrieval cycle may produce search results, rankings, and a heatmap that localize matching seismic expressions in a selected survey. The export cycle may produce a package that may be delivered to a subsurface platform for validation and further analysis.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 6.1, the computing system (600) may include one or more computer processor(s) (602), non-persistent storage device(s) (604), persistent storage device(s) (606), a communication interface (608) (e.g., Bluetooth interface, infrared interface, network interface, optical interface, etc.), and numerous other elements and functionalities that implement the features and elements of the disclosure. The computer processor(s) (602) may be an integrated circuit for processing instructions. The computer processor(s) (602) may be one or more cores, or micro-cores, of a processor. The computer processor(s) (602) includes one or more processors. The computer processor(s) (602) may include a central processing unit (CPU), a graphics processing unit (GPU), a tensor processing unit (TPU), combinations thereof, etc.

The input device(s) (610) may include a touchscreen, keyboard, mouse, microphone, touchpad, electronic pen, or any other type of input device. The input device(s) (610) may receive inputs from a user that are responsive to data and messages presented by the output device(s) (612). The inputs may include text input, audio input, video input, etc., which may be processed and transmitted by the computing system (600) in accordance with one or more embodiments. The communication interface (608) may include an integrated circuit for connecting the computing system (600) to a network (not shown) (e.g., a local area network (LAN), a wide area network (WAN) such as the Internet, mobile network, or any other type of network) or to another device, such as another computing device, and combinations thereof.

Further, the output device(s) (612) may include a display device, a printer, external storage, or any other output device. One or more of the output device(s) (612) may be the same or different from the input device(s) (610). The input device(s) (610) and output device(s) (612) may be locally or remotely connected to the computer processor(s) (602). Many different types of computing systems exist, and the aforementioned input device(s) (610) and output device(s) (612) may take other forms. The output device(s) (612) may display data and messages that are transmitted and received by the computing system (600). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid-state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (702), is configured to perform one or more embodiments, which may include transmitting, receiving, presenting, and displaying data and messages described in the other figures of the disclosure.

The computing system (600) in FIG. 6.1 may be connected to, or be a part of, a network. For example, as shown in FIG. 6.2, the network (620) may include multiple nodes (e.g., node X (622) and node Y (624), as well as extant intervening nodes between node X (622) and node Y (624)). Each node may correspond to a computing system, such as the computing system shown in FIG. 6.1, or a group of nodes combined may correspond to the computing system shown in FIG. 6.1. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (600) may be located at a remote location and connected to the other elements over a network.

The nodes (e.g., node X (622) and node Y (624)) in the network (620) may be configured to provide services for a client device (626). The services may include receiving requests and transmitting responses to the client device (626). For example, the nodes may be part of a cloud computing system. The client device (626) may be a computing system, such as the computing system shown in FIG. 6.1. Further, the client device (626) may include or perform all or a portion of one or more embodiments.

The computing system of FIG. 6.1 may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
receiving, by an artificial intelligence (AI) agent, a natural language request from a user application to retrieve a seismic survey having at least one seismic profile matching a reference seismic profile of a geological model;
processing, by a large language model (LLM), the natural language request to generate a plurality of processing steps and identifying corresponding tools to obtain the seismic survey;
constructing, by the AI agent, based on the plurality of processing steps, an execution graph comprising a plurality of nodes connected by a plurality of edges, wherein constructing the execution graph comprises instantiating the plurality of nodes for the corresponding tools of the plurality of processing steps; and
executing, by the AI agent, the execution graph to obtain the seismic survey with the at least one seismic profile that matches the reference seismic profile of the geological model.

2. The method of claim 1, wherein executing the execution graph by the AI agent comprises:
traversing to each node of the plurality of nodes of the execution graph, wherein traversing to each node comprises:
invoking, using an application programming interface (API) of a geological model builder tool, the geological model builder tool in a first node to generate a geological model,
invoking, using an API of a seismic profile generator tool, the seismic profile generator tool in a second node to generate a seismic profile of the geological model, and corresponding embeddings of the seismic profile,
invoking, using an API of a similarity search tool, the similarity search tool in a third node to retrieve a plurality of search results for the seismic profile, the plurality of search results comprising a plurality of seismic sections,
invoking, using an API of a survey recommendation tool, the survey recommendation tool in a fourth node to output a ranked list of seismic surveys, based on the plurality of search results,
invoking, using an API of a heatmap generator tool, the heatmap generator tool in a fifth node to generate a heatmap of similarity values of the seismic profile with respect to a top-ranked seismic survey of the ranked list of seismic surveys, and
invoking, using an API of a platform connector tool, the platform connector tool in a sixth node to upload the geological model, the seismic profile, the heatmap and the top-ranked survey to a subsurface platform.

3. The method of claim 1, wherein executing the execution graph further comprises:
triggering executing, by the AI agent, a first tool at a first node of the plurality of nodes of the execution graph,
outputting, by the first tool at the first node of the execution graph, a first output,
transmitting, by the AI agent, the first output generated by the first tool to the user application,
receiving, by the AI agent, a second natural language request from the user application, based on the first output,
prompting the LLM to process the second natural language request to determine a second tool for generating a second output corresponding to the second natural language request, and
triggering execution of the second tool at a second node of the plurality of nodes of the execution graph, to generate the second output.

4. The method of claim 1, wherein executing the execution graph further comprises:
executing a geological model builder tool at a node of the plurality of nodes of the execution graph to perform operations comprising:
prompting the LLM to extract a plurality of features and a plurality of corresponding feature values of the geological model from the natural language request,
generating a geological model and a corresponding geological model image using the plurality of features and the plurality of corresponding feature values, and
transmitting the geological model and the corresponding geological model image to the user application.

5. The method of claim 1, wherein executing the execution graph further comprises:
executing a geological model builder tool at a node of the plurality of nodes of the execution graph to perform operations comprising:
receiving a second natural language request from the user application comprising a modification to a feature of the geological model,
obtaining, from the LLM processing the second natural language request, updated feature data comprising the feature and a corresponding modified feature value,
generating an updated geological model and a corresponding updated geological model image using the updated feature data, and
transmitting the updated geological model and the corresponding updated geological model image to the user application.

6. The method of claim 1, wherein executing the execution graph further comprises:
executing a seismic profile generator tool at a node of the plurality of nodes of the execution graph to perform operations comprising:
receiving an updated geological model,
transmitting a forward‑modeling request comprising the updated geological model to a seismic foundation model,
obtaining the reference seismic profile of the geological model, wherein the reference seismic profile is generated by the seismic foundation model by forward-modeling the updated geological model, and
transmitting the reference seismic profile to the user application.

7. The method of claim 1, wherein executing the execution graph further comprises:
executing a similarity search tool at a node of the plurality of nodes of the execution graph to perform operations comprising:
receiving the reference seismic profile,
generating an embedding of the reference seismic profile,
transmitting the embedding to a seismic foundation model,
obtaining, from the seismic foundation model performing a sparse-sample search using the embedding, a plurality of search results comprising a plurality of seismic sections, a plurality of corresponding candidate locations of the plurality of seismic sections, and a plurality of seismic survey identifiers, and
transmitting, by the similarity search tool, the plurality of search results, and the plurality of corresponding candidate locations to the AI agent.

8. The method of claim 1, wherein executing the execution graph further comprises:
executing a survey recommendation tool at a node of the plurality of nodes of the execution graph to perform operations comprising:
receiving a plurality of search results comprising a plurality of seismic sections, a plurality of corresponding similarity scores, and a plurality of corresponding candidate locations,
computing, by the survey recommendation tool, a candidate location ranking of the plurality of search results based at least on the plurality of corresponding similarity scores of the plurality of seismic sections to the reference seismic profile to obtain a ranked list of candidate locations, and
transmitting, by the survey recommendation tool, the ranked list of seismic surveys corresponding to the ranked list of candidate locations to the AI agent.

9. The method of claim 1, wherein executing the execution graph further comprises:
executing a heatmap generator tool at a node of the plurality of nodes of the execution graph to perform operations comprising:
receiving a top-ranked seismic survey, and the reference seismic profile,
transmitting a request comprising the top-ranked seismic survey and the reference seismic profile to a seismic foundation model,
obtaining a plurality of similarity scores between a plurality of sub‑windows of the top-ranked seismic survey and the reference seismic profile,
wherein the plurality of similarity scores are generated by the seismic foundation model,
generating, by the heatmap generator tool, a heatmap representing the plurality of similarity scores, and
transmitting the heatmap to the AI agent.

10. The method of claim 1, executing the execution graph further comprises:
executing a platform connector tool at a node of the plurality of nodes of the execution graph to perform operations comprising:
generating a plurality of export formats of outputs of a plurality of tools of the execution graph, and
transmitting the plurality of export formats of the outputs to a subsurface platform.

11. A system comprising:
at least one computer processor;
a large language model (LLM), executing on the at least one computer processor; and
an artificial intelligence (AI) agent, executing on the at least one computer processor, and configured to:
receive a natural language request from a user application to retrieve a seismic survey having at least one seismic profile matching a reference seismic profile of a geological model,
prompt the LLM to process the natural language request to generate a plurality of processing steps and identify corresponding tools to obtain the seismic survey,
construct, based on the plurality of processing steps, an execution graph comprising a plurality of nodes connected by a plurality of edges,
wherein constructing the execution graph comprises instantiating the plurality of nodes for the corresponding tools of the plurality of processing steps, and
execute the execution graph to obtain the seismic survey with the at least one seismic profile that matches the reference seismic profile of the geological model.

12. The system of claim 11, further comprising:
a plurality of tools comprising a geological model builder tool, a seismic profile generator tool, a similarity search tool, a survey recommendation tool, a heatmap generator tool, a platform connector tool, a platform connector tool,
wherein executing the execution graph comprises:
traversing to each node of the plurality of nodes of the execution graph, wherein traversing to each node comprises:
triggering the geological model builder tool in a first node to generate a geological model,
triggering the seismic profile generator tool in a second node to generate a seismic profile of the geological model, and corresponding embeddings of the seismic profile,
triggering the similarity search tool in a third node to retrieve a plurality of search results for the seismic profile, the plurality of search results comprising a plurality of seismic sections,
triggering the survey recommendation tool in a fourth node to output a ranked list of seismic surveys, based on the plurality of search results,
triggering the heatmap generator tool in a fifth node to generate a heatmap of similarity values of the seismic profile with respect to a top-ranked seismic survey of the ranked list of seismic surveys, and
triggering the platform connector tool in a sixth node to upload the geological model, the seismic profile, the heatmap and the top-ranked survey to a subsurface platform.

13. The system of claim 11, wherein the AI agent is further configured to:
execute a first tool at a first node of the plurality of nodes of the execution graph,
transmit a first output generated by the first tool executing at the first node to the user application,
receive a second natural language request from the user application, based on the first output,
prompt the LLM to process the second natural language request to determine a second tool for generating a second output corresponding to the second natural language request, and
trigger execution of the second tool at a second node of the plurality of nodes of the execution graph, to generate the second output.

14. The system of claim 11, further comprising:
a geological model builder tool triggered by a node of the plurality of nodes of the execution graph and configured to:
prompt the LLM to extract a plurality of features and of a plurality of corresponding feature values of the geological model from the natural language request,
generate a geological model and a corresponding geological model image using the plurality of features and the plurality of corresponding feature values, and
transmit the geological model and the corresponding geological model image to the user application.

15. The system of claim 11, further comprising:
a geological model builder tool triggered by a node of the plurality of nodes of the execution graph and configured to:
receive a second natural language request from the user application comprising a modification to a feature of the geological model,
obtain, from the LLM processing the second natural language request, updated feature data comprising the feature and a corresponding modified feature value,
generate an updated geological model and a corresponding updated geological model image based on the updated feature data, and
transmit the updated geological model and the corresponding updated geological model image to the user application.

16. The system of claim 11, further comprising:
a seismic profile generator tool triggered by a node of the plurality of nodes of the execution graph and configured to:
receive an updated geological model,
transmit a forward‑modeling request comprising the updated geological model to a seismic foundation model,
obtain the reference seismic profile of the geological model, wherein the reference seismic profile is generated by the seismic foundation model by forward-modeling the updated geological model, and
transmit the reference seismic profile to the user application.

17. The system of claim 11, further comprising:
a similarity search tool triggered by a node of the plurality of nodes of the execution graph and configured to:
receive the reference seismic profile,
generate an embedding of the reference seismic profile,
transmit the embedding to a seismic foundation model,
obtain, from the seismic foundation model performing a sparse-sample search using the embedding, a plurality of search results comprising a plurality of seismic sections, a plurality of corresponding candidate locations of the plurality of seismic sections, wherein the search results are generated by, and
transmit the plurality of search results, and the plurality of corresponding candidate locations to the AI agent.

18. The system of claim 11, further comprising:
a survey recommendation tool triggered by a node of the plurality of nodes of the execution graph and is configured to:
receive a plurality of search results comprising a plurality of seismic sections and a plurality of corresponding candidate locations,
compute a candidate location ranking of the plurality of search results based at least on a plurality of similarity scores of the plurality of seismic sections to the reference seismic profile to obtain a ranked list of candidate locations,
generate a ranked list of seismic surveys corresponding to the ranked list of candidate locations, and
transmit the ranked list of seismic surveys to the AI agent.

19. The system of claim 11, further comprising:
a heatmap generator tool triggered by a node of the plurality of nodes of the execution graph and is configured to:
receive a top-ranked seismic survey and the reference seismic profile,
transmit a request comprising the top-ranked seismic survey and the reference seismic profile to a seismic foundation model,
obtain a plurality of similarity scores between a plurality of seismic profiles of a plurality of sub‑windows of the top-ranked seismic survey and the reference seismic profile, wherein the plurality of similarity scores are generated by the seismic foundation model,
generate a heatmap representing the similarity scores, and
transmit the heatmap to the AI agent.

20. A non-transitory computer readable medium comprising computer readable program code for causing a computer system to perform operations comprising:
receiving, by an artificial intelligence (AI) agent, a natural language request from a user application to retrieve a seismic survey having at least one seismic profile matching a reference seismic profile of a geological model,
processing, by a large language model (LLM), the natural language request to generate a plurality of processing steps and identify corresponding tools to obtain the seismic survey,
constructing, by the AI agent, based on the plurality of processing steps, an execution graph comprising a plurality of nodes connected by a plurality of edges, wherein constructing the execution graph comprises instantiating the plurality of nodes for the corresponding tools of the plurality of processing steps, and
executing, by the AI agent, the execution graph to obtain the seismic survey with the at least one seismic profile that matches the reference seismic profile of the geological model.
